(19) United States
(12) Patent Application Publication
(10) Pub. No.: US 2019/0303942 A1
(43) Pub. Date: Oct. 3, 2019

(54) FRAUD MANAGEMENT USING A DISTRIBUTED DATABASE

(71) Applicant: American Express Travel Related Services Company, Inc., New York, NY (US)

(72) Inventors: Balaji Balaraman, Bangalore (IN); Rana Dasgupta, Scottsdale, AZ (US); Andras L. Ferenczi, Peoria, AZ (US); Vishnu Garg, Phoenix, AZ (US); Chad Gonzales, Glendale, AZ (US); Farid G. Hatefi, Chandler, AZ (US); Abhishek Jha, Scottsdale, AZ (US); Upendra Mardikar, San Jose, CA (US); Sulubh Monga, Scottsdale, AZ (US); Harish R. Naik, Phoenix, AZ (US); Timothy O. Rollins, Cave Creek, AZ (US)

(73) Assignee: American Express Travel Related Services Company, Inc., New York, NY (US)

(21) Appl. No.: 15/943,271

(22) Filed: Apr. 2, 2018

(51) Int. Cl. G06Q 20/40; H04L 29/06; H04L 9/06

(52) U.S. Cl. CPC G06Q 20/4016; H04L 63/102; H04L 9/0643; G06Q 2220/00; H04L 2209/56; H04L 2209/38; H04L 9/0637

(57) ABSTRACT

Systems and methods for fraud management using a distributed database are disclosed. The system may receive a payment request and generate a payment request hash by cryptographically processing the payment request using a hashing algorithm. The system may invoke a fraud reporting smart contract by passing the payment request hash and a public blockchain address to the fraud reporting smart contract. The system may query a local blockchain database to locate a fraud report matching the payment request hash to determine whether the payment request has been previously reported as fraud. In response to the payment request hash not matching the fraud report, the fraud reporting smart contract is configured to write the payment request hash to the blockchain as a second fraud report.

### FIELD

This disclosure generally relates to fraud management, and more particularly, to systems and methods for reporting, collecting, and managing transaction fraud using a distributed database.

### BACKGROUND

Payment networks include various systems for processing transactions between merchants and customers. Merchants are members of the payment network and the merchants may be authorized to charge to customer accounts. Customers have a transaction account with the payment network. To complete a transaction, a merchant typically transmits a payment request (or settlement) to the payment network with transaction details and the customer account information. Typically, the payment network authorizes the payment request by assessing a transaction risk and/or debiting the transaction account.

Fraud occurring during transactions cost consumers, merchants, issuers, and other parties billions of dollars a year. Systems and third parties supported by the payment network and configured to detect and report fraud may further increase costs associated with security and infrastructure. Additionally, reports of known fraud or suspected fraud may not occur in real time. Such delays at least partially reduce the ability of the payment network to accurately and quickly detect fraud as transactions are processed and before the transaction is completed.

### SUMMARY

A system, method, and computer readable medium (collectively, the “system”) is disclosed for fraud management using blockchain. The system may receive a payment request. The system may generate a payment request hash by cryptographically processing the payment request using a hashing algorithm. The system may invoke a fraud reporting smart contract by passing the payment request hash and a public blockchain address to the fraud reporting smart contract. The system may query a local blockchain database to locate a fraud report matching the payment request hash to determine whether the payment request has been previously reported as fraud. In response to the payment request hash not matching the fraud report, the fraud reporting smart contract may be configured to write the payment request hash to the blockchain as a second fraud report.

In various embodiments, the fraud report may comprise a confidence level having a fraud report count and a user reputation level. In response to the query locating the fraud report matching the payment request hash, the fraud reporting smart contract may be configured to increase the fraud report count and the confidence level of the fraud report. The user reputation level may be based on at least one of an accuracy of fraud reporting, a count of fraud reports that have been reported by users, and a volume of unconfirmed fraud reports. In various embodiments, in response to the fraud report originating from a transaction account issuer, the confidence level comprises a value indicating a validated fraud record. In various embodiments, the fraud report may be cryptographically processed using the hashing algorithm prior to being stored in the blockchain. The hashing algorithm may be a SHA-2 hashing algorithm.

In various embodiments, the system may receive a fraud management registration request comprising the public blockchain address and identifying information. The system may authenticate the fraud management registration request by comparing the identifying information against stored identity data. The system may grant fraud management access rights to the public blockchain address in response to locating stored identity data matching the identifying information. In various embodiments, the system may also validate the public blockchain address passed to the fraud reporting smart contract to determine fraud management access rights to the blockchain.

In various embodiments, the payment request may comprise at least one of a transaction account number, a transaction instrument number, a transaction instrument expiration date, transaction account billing information, a user email address, and an IP address.

The forgoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION

The subject matter of the present disclosure is particularly pointed out and distinctly claimed in the concluding portion of the specification. However, a more complete understanding of the present disclosure may be obtained by referring to the detailed description and claims when considered in connection with the drawing figures, wherein like numerals denote like elements.

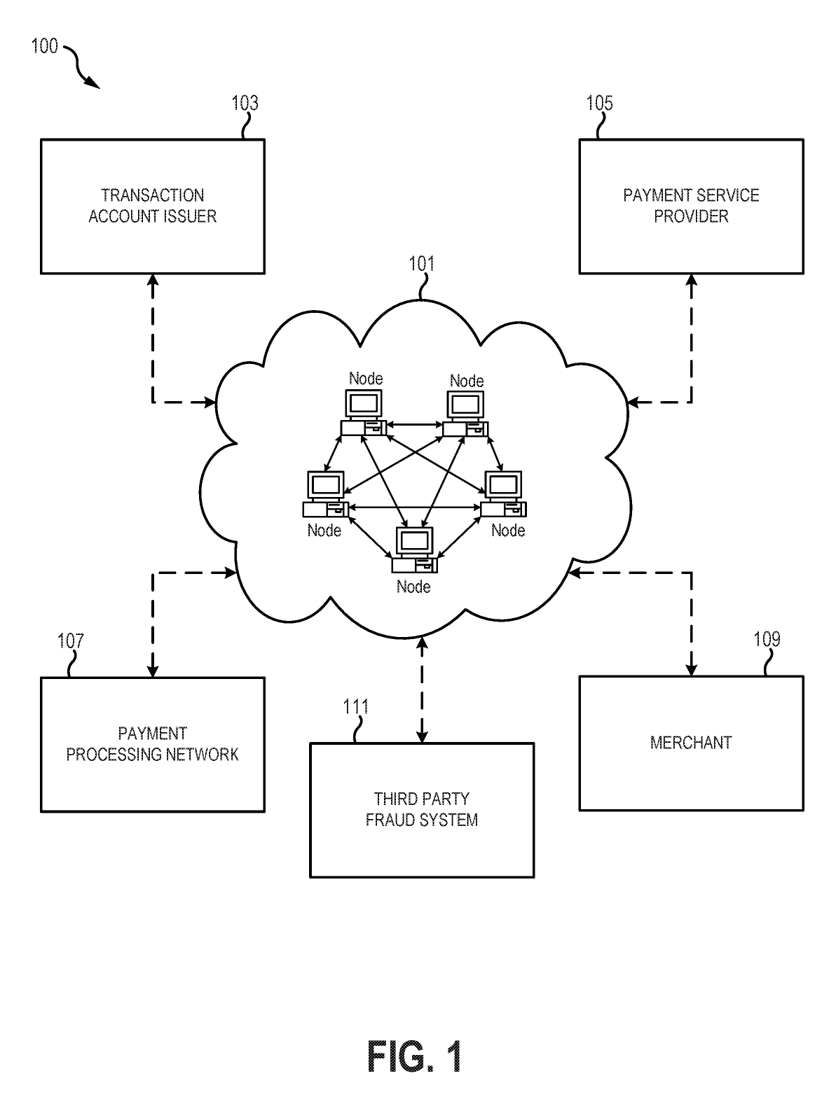

FIG. 1 illustrates a fraud management system, in accordance with various embodiments;

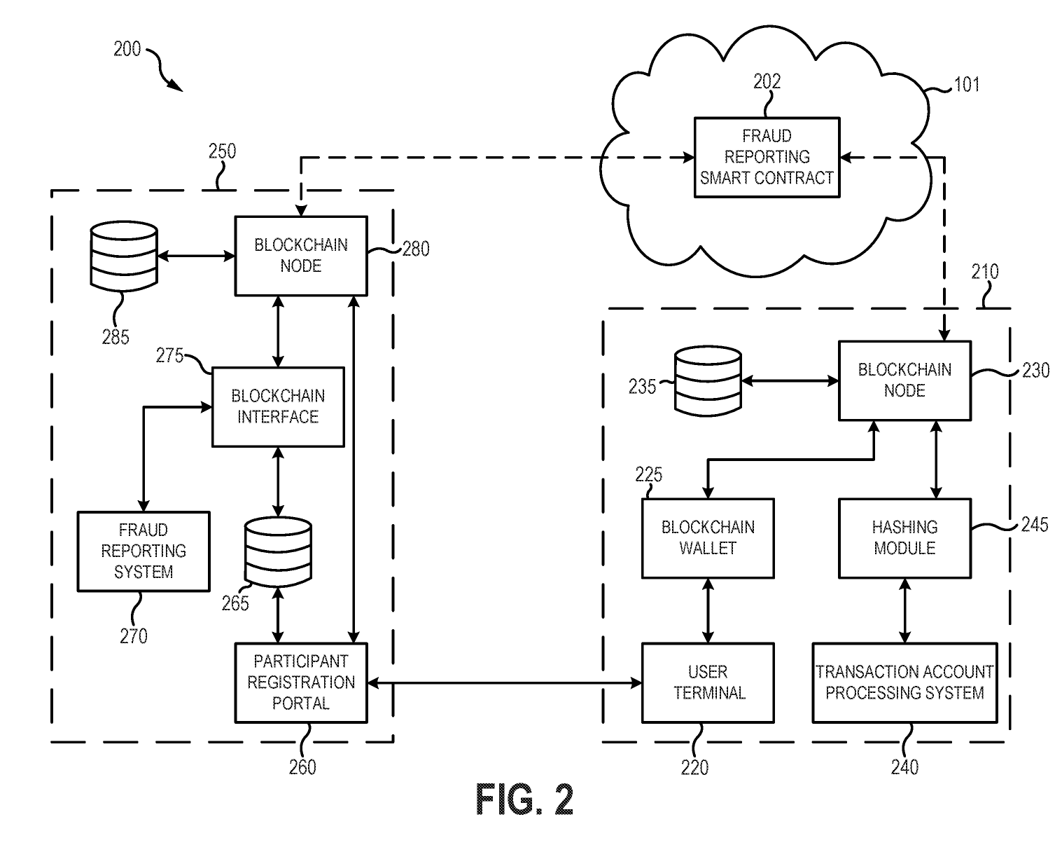

FIG. 2 illustrates an exemplary fraud management system, in accordance with various embodiments;

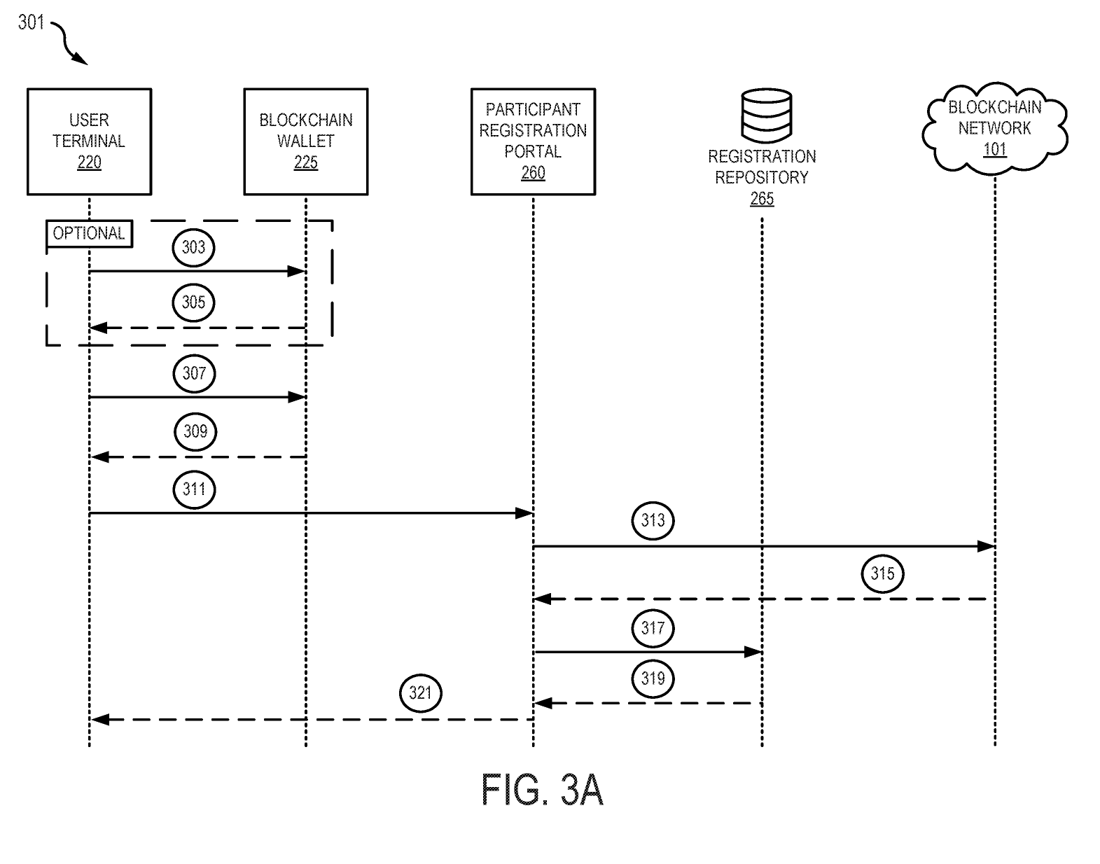

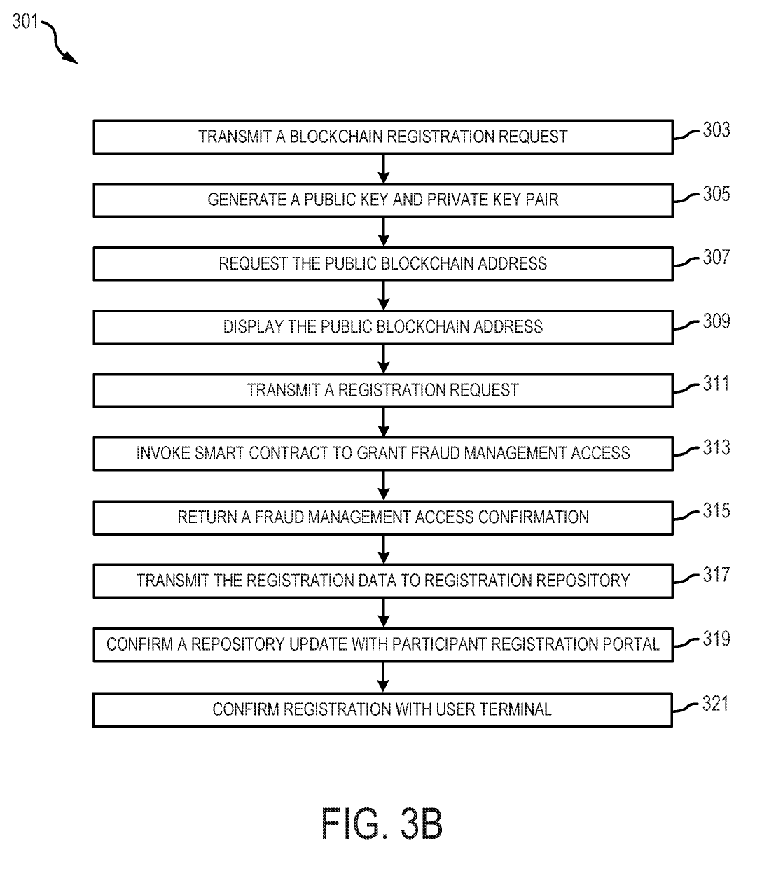

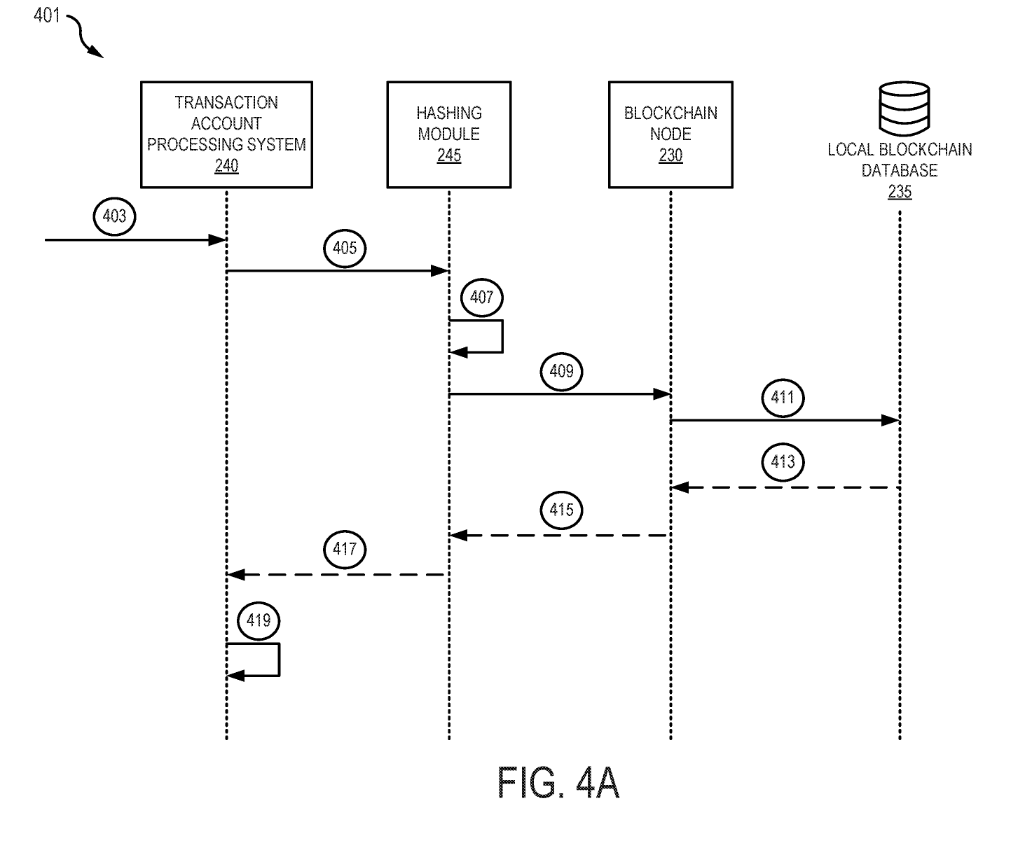

FIGS. 3A and 3B illustrate a process flow for registration in a fraud management blockchain system, in accordance with various embodiments;

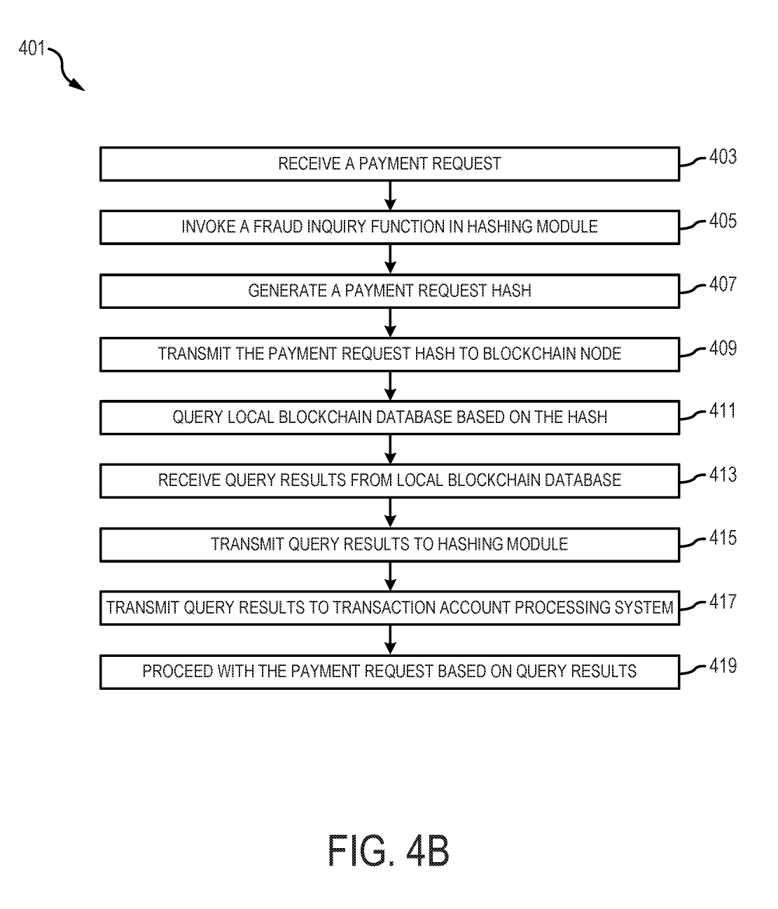

FIGS. 4A and 4B illustrate a process flow for submitting a fraud inquiry in the fraud management blockchain system, in accordance with various embodiments;

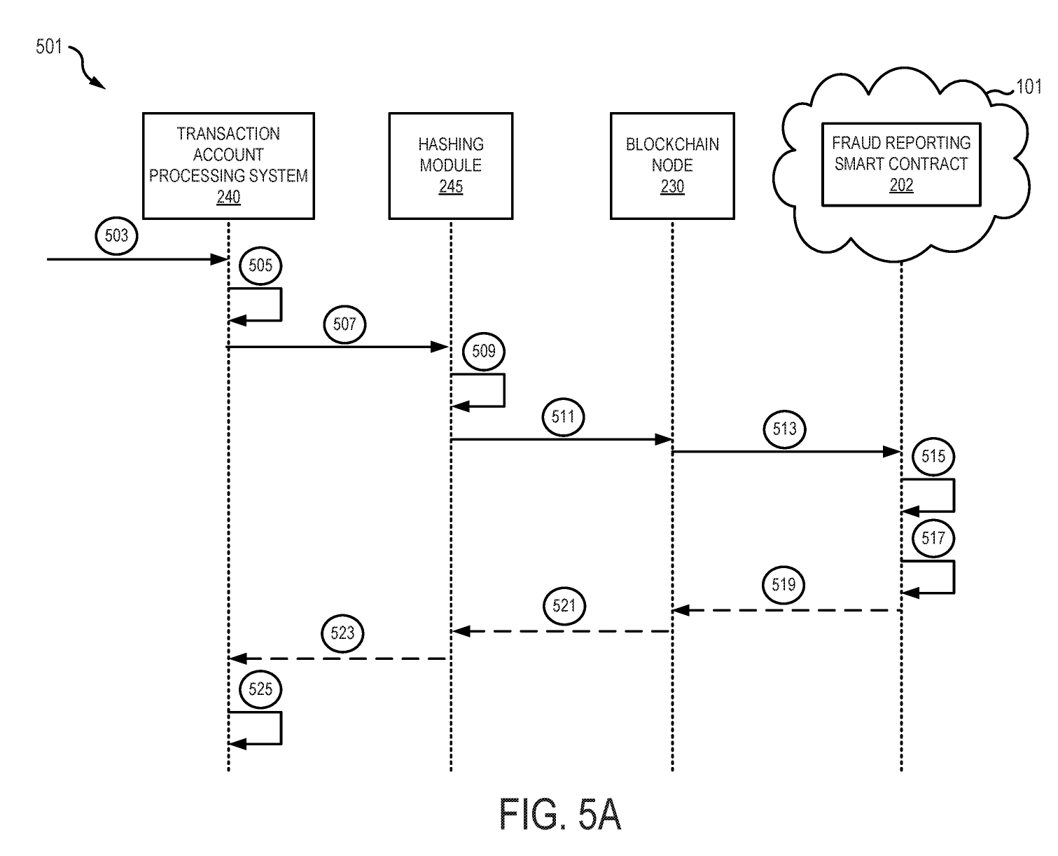

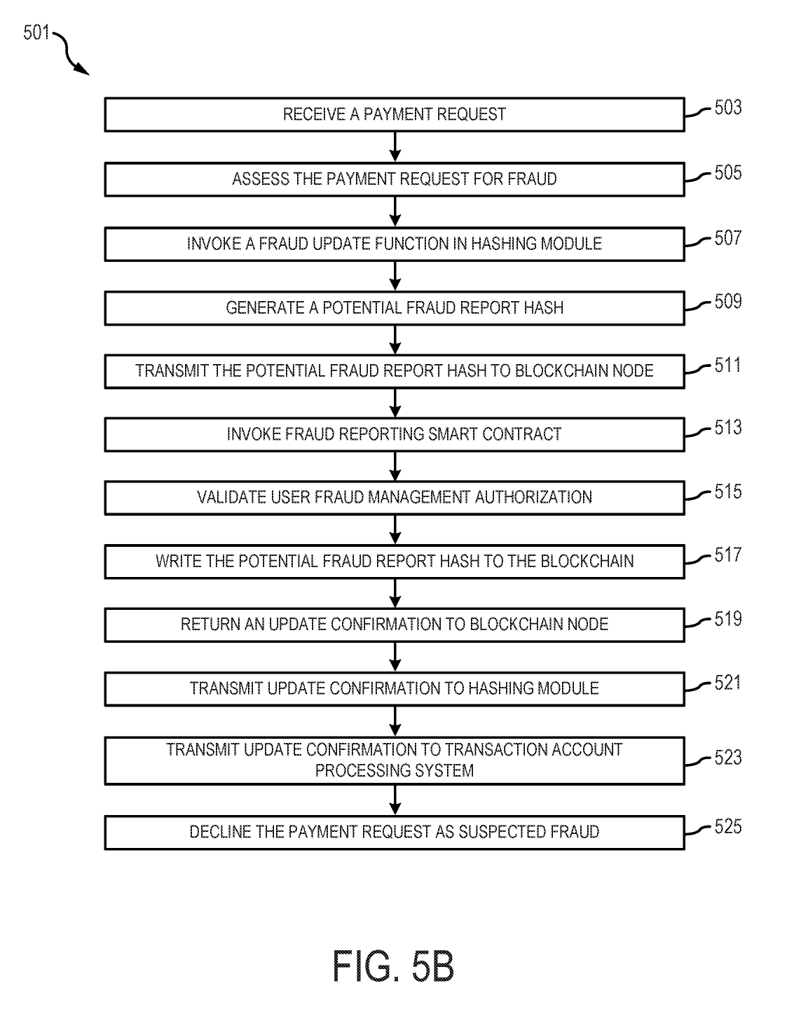

FIGS. 5A and 5B illustrate a process flow for reporting potential fraud in a fraud management blockchain system, in accordance with various embodiments; and

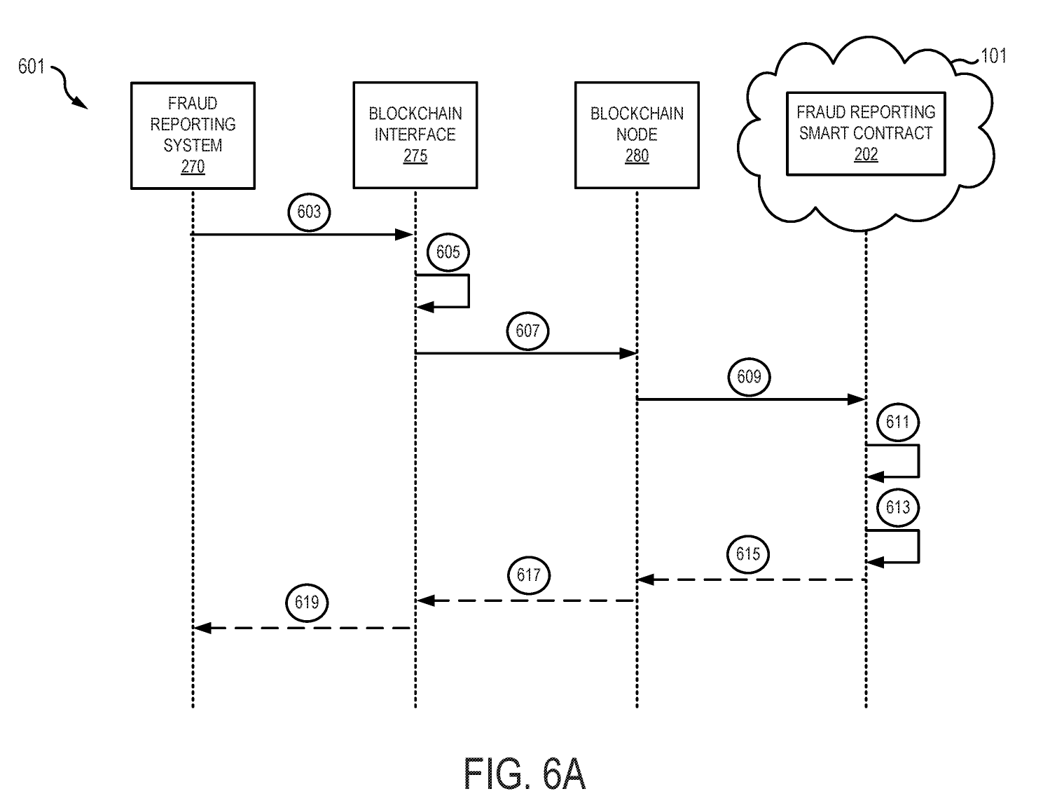

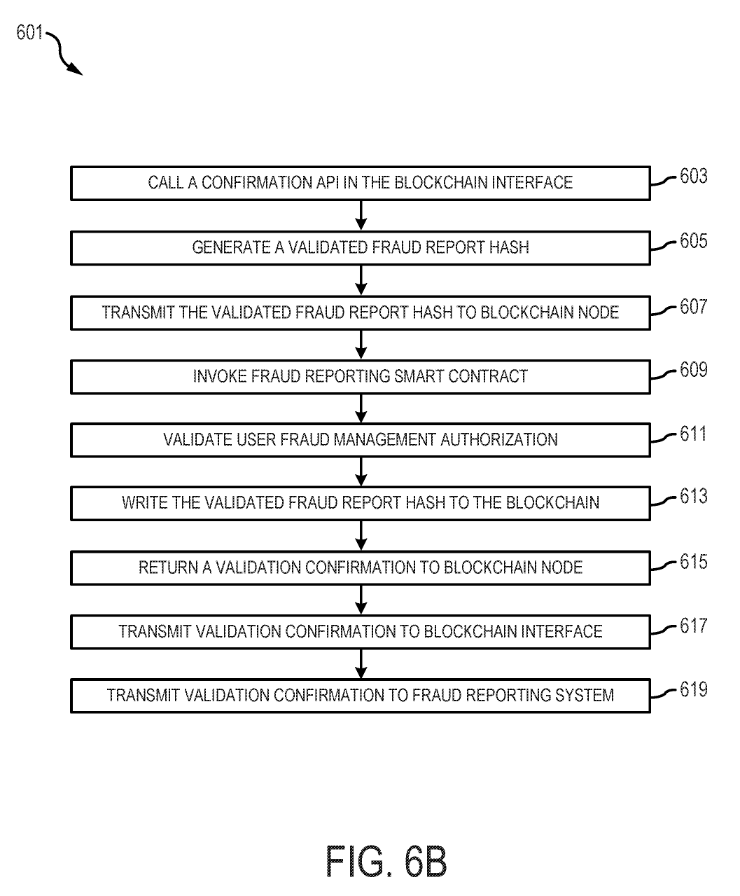

FIGS. 6A and 6B illustrate a process flow for reporting validated fraud in a fraud management blockchain system, in accordance with various embodiments.

### DETAILED DESCRIPTION

The detailed description of various embodiments refers to the accompanying drawings, which show various embodiments by way of illustration. While these various embodiments are described in sufficient detail to enable those skilled in the art to practice the disclosure, it should be understood that other embodiments may be realized and that logical and physical changes may be made without departing from the spirit and scope of the disclosure. Thus, the detailed description is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The system may comprise one or more “users” in communication with a blockchain. The users may include, for example, transaction account issuers, payment service providers, payment processing entities, merchants, third party fraud systems, and/or any other network, system, or entity participating during a transaction. The system may comprise a marketplace or crowdsource-based system, wherein various users can interact in real-time to submit fraud inquiries, proposed fraud reports, and/or to validate proposed fraud reports. In that regard, the users can verify payment authorization requests against data stored within the blockchain and the system may stop processing of transaction requests, in response to determining that the transaction is fraudulent. In that regard, a marketplace or crowdsource-based system may connect all parties that have a common interest to eradicate fraud throughout transaction processes.

The system may employ or interact with a traditional account payment network to facilitate purchases and payments, authorize transactions and/or settle transactions. For example, the traditional account payment network may represent existing proprietary networks that presently accommodate transactions for credit cards, debit cards, and/or other types of transaction accounts or transaction instruments. The traditional account payment network may comprise an exemplary transaction network such as American Express®, VisaNet®, MasterCard®, Discover®, Interac®, Cartes Bancaires, JCB®, private networks (e.g., department store networks), and/or any other payment network.

The systems, methods, and computer readable mediums (collectively, the “system”) described herein, in accordance with various embodiments, may use a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

The system may integrate smart contracts that enforce fraud management and/or fraud reporting, along with inquiring workflows in a decentralized manner. The system may manage, validate, and/or keep track of fraud inquiries, proposed fraud reports, and/or validated fraud reports. Fraud management processes performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a Hyperledger® Fabric 1.0 based platform, the duration is driven by the specific consensus algorithm that is chosen, and may be performed within seconds. In that respect, propagation times in the system may be improved compared to existing fraud systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network. Moreover, the system may also offer increased security of consumer data by performing cryptographic processes on consumer data prior to querying the blockchain or storing data on the blockchain. For more information on distributed ledgers implementing features and functionalities of blockchain, see U.S. application Ser. No. 15/266,350 titled SYSTEMS AND METHODS FOR BLOCKCHAIN BASED PAYMENT NETWORKS and filed on Sep. 15, 2016, U.S. application Ser. No. 15/682,180 titled SYSTEMS AND METHODS FOR DATA FILE TRANSFER BALANCING AND CONTROL ON BLOCKCHAIN and filed Aug. 21, 2017, U.S. application Ser. No. 15/728,086 titled SYSTEMS AND METHODS FOR LOYALTY POINT DISTRIBUTION and filed Oct. 9, 2017, U.S. application Ser. No. 15/785,843 titled MESSAGING BALANCING AND CONTROL ON BLOCKCHAIN and filed on Oct. 17, 2017, U.S. application Ser. No. 15/785,870 titled API REQUEST AND RESPONSE BALANCING AND CONTROL ON BLOCKCHAIN and filed on Oct. 17, 2017, U.S. application Ser. No. 15/824,450 titled SINGLE SIGN-ON SOLUTION USING BLOCKCHAIN and filed on Nov. 28, 2017, and U.S. application Ser. No. 15/824,513 titled TRANSACTION AUTHORIZATION PROCESS USING BLOCKCHAIN and filed on Nov. 28, 2017, the contents of which are each incorporated by reference in its entirety.

With reference to FIG. 1, a fraud management blockchain system 100 is depicted according to various embodiments. System 100 may include various computing devices, software modules, networks, and data structures in communication with one another. System 100 may also contemplate uses in association with web services, utility computing, pervasive and individualized computing, security and identity solutions, autonomic computing, cloud computing, commodity computing, mobility and wireless solutions, open source, biometrics, grid computing and/or mesh computing. System 100 based on a blockchain, as described herein, may simplify and automate fraud management and related processes by using the blockchain as a distributed and tamper-proof data store. Transparency is very high for various embodiments using a federated or public blockchain since validation is performed, for example, using data stored by a decentralized autonomous organization (DAO) instead of a specific financial institution.

System 100 may comprise a blockchain network 101 configured to maintain a blockchain, in accordance with various embodiments. Blockchain network 101 may be a peer-to-peer network that is private, federated, and/or public in nature (e.g., ETHEREUM®, Bitcoin, Hyperledger® Fabric, etc.). Federated and private networks may offer improved control over the content of the blockchain and public networks may leverage the cumulative computing power of the network to improve security. Blockchain network 101 may comprise various blockchain nodes (e.g., consensus participants) in electronic communication with each other, as discussed further herein. Each blockchain node may comprise a computing device configured to write blocks to the blockchain and validate blocks of the blockchain. The computing devices may take the form of a computer or processor, or a set of computers and/or processors or application specific integrated circuits (ASICs), although other types of computing units or systems may also be used. Exemplary computing devices include servers, pooled servers, laptops, notebooks, hand held computers, personal digital assistants, cellular phones, smart phones (e.g., iPhone®, BlackBerry®, Android®, etc.) tablets, wearables (e.g., smart watches and smart glasses), Internet of things (IOT) devices or any other device capable of receiving data over network. Each computing device may run applications to interact with blockchain network 101, communicate with other devices, perform crypto operations, and otherwise operate within system 100. Computing devices may run a client application that can be a thin client (web), hybrid (i.e. web and native, such as iOS and Android), or native application to make API calls to interact with the blockchain, such as a web3 API compatible with blockchain databases maintained by ETHEREUM®.

The blockchain may be a distributed database, distributed ledger, or the like that maintains records in a readable manner and that is resistant to tampering. The blockchain may be based on any blockchain technology such as, for example, Ethereum, Open Chain, Chain Open Standard, Hyperledger Fabric, Corda, CONNECT®, INTEL® Sawtooth, etc. The blockchain may comprise a system of blocks containing data that are interconnected by reference to the previous block. The blocks can hold proposed fraud reports, validated fraud reports, and/or other information as desired. Each block may link to the previous block and may include a timestamp. Data can be added to the blockchain by establishing consensus between the blockchain nodes based on proof of work, proof of stake, practical byzantine fault tolerance, delegated proof of stake, or other suitable consensus algorithms. When implemented in support of system 100, the blockchain may serve as an immutable log for proposed fraud reports, validated fraud reports, and/or other information as desired.

In various embodiments, blockchain network 101 may use a Hierarchical Deterministic (HD) solution and may use BIP32, BIP39, and/or BIP44, for example, to generate an HD tree of public addresses. System 100 may include various computing devices configured to interact with blockchain network 101 either via a blockchain client, such as GETH, or via API calls using a blockchain as a service provider, such as MICROSOFT AZURE® or Blockapps STRATO, for example. The various computing devices of system 100 may be configured to store fraud related data and execute smart contracts using blockchain network 101 for data storage and/or validation. The smart contracts may be completed by digital signature using asymmetric crypto operations and a private key, for example, and as discussed further herein.

In various embodiments, system 100 may comprise one or more of a transaction account issuer 103, a payment service provider 105, a payment processing network 107, a merchant 109, and/or a third party fraud system 111. Each transaction account issuer 103, payment service provider 105, payment processing network 107, merchant 109, and/or third party fraud system 111 may be in electronic communication with blockchain network 101 and may run applications to interact with blockchain network 101, transfer files over a network with other computing devices, perform crypto operations, and otherwise operate within system 100. For example, each transaction account issuer 103, payment service provider 105, payment processing network 107, merchant 109, and/or third party fraud system 111 may comprise a blockchain node configured to interact with blockchain network 101. A blockchain address may be uniquely assigned to each transaction account issuer 103, payment service provider 105, payment processing network 107, merchant 109, and/or third party fraud system 111 to function as a unique identifier for each respective transaction account issuer 103, payment service provider 105, payment processing network 107, merchant 109, and/or third party fraud system 111.

In various embodiments, each transaction account issuer 103, payment service provider 105, payment processing network 107, merchant 109, and/or third party fraud system 111 may be configured to interact with blockchain network 101 to review, collect, and/or submit fraud information. In that respect, each transaction account issuer 103, payment service provider 105, payment processing network 107, merchant 109, and/or third party fraud system 111 may comprise any suitable entity, system, network, or the like desiring to obtain, review, or submit fraud information.

For example, transaction account issuer 103 may comprise any transaction account issuing entity such as, for example, Citigroup®, Capital One®, Bank of America®, Discover®, Synchrony Financial®, American Express®, Wells Fargo®, Barclays®, U.S. Bank®, Delta Airlines®, Morgan Stanley®, and/or the like. For example, payment processing network 107 may comprise any payment processing network or entity such as American Express®, Discover®, MasterCard®, VisaNet®, Interac®, Cartes Bancaires, JCB®, private networks (e.g., department store networks), or the like. For example, payment service provider 105 may comprise any entity, network, or payment service provider that offers services for payments, such as Adyen®, BitPay®, Braintree®, PayPal®, Square®, Stripe or the like. For example, merchant 109 may comprise any suitable online or in-person merchant entity such as Amazon®, eBay®, Walmart®, Target®, or the like. For example, third party fraud system 111 may comprise any suitable fraud detection or alerting entity, system, network, or the like, such as InAuth, Inc., Syntec®, Vantiv®, or the like. As a further example, merchant 109 may comprise an online commerce provider such as, for example, Volusion®, BigCommerce.com, Wix.com, or the like.

In various embodiments, and with reference to FIG. 2, a fraud management blockchain system 200 is depicted in greater detail. System 200 may comprise a fraud inquiry network 210 and/or a fraud reporting network 250 in electronic and/or operative communication with blockchain network 101. Fraud inquiry network 210 may comprise a blockchain node 230 (e.g., a first blockchain node) integrated into blockchain network 101 and configured to allow access to blockchain network 101 via fraud inquiry network 210. Blockchain node 230 may be in electronic and/or logical communication with local blockchain database 235 (e.g., a first local blockchain database). Local blockchain database 235 may be configured to store a local copy of the blockchain for access by fraud inquiry network 210. Data in local blockchain database 235 may be continually updated by blockchain network 101, via blockchain node 230, according to a peer-to-peer gossip protocol of blockchain network 101. Fraud reporting network 250 may comprise a blockchain node 280 (e.g., a second blockchain node) integrated into blockchain network 101 and configured to allow access to blockchain network 101 via fraud reporting network 250. Blockchain node 280 may be in electronic and/or logical communication with local blockchain database 285 (e.g., a second local blockchain database). Local blockchain database 285 may be configured to store a local copy of the blockchain for access by fraud reporting network 250. Data in local blockchain database 285 may be continually updated by blockchain network 101, via blockchain node 280, according to a peer-to-peer gossip protocol of blockchain network 101.

Blockchain network 101 may comprise a fraud reporting smart contract 202. Fraud reporting smart contract 202 may be configured to control the end-to-end flow of fraud management, including fraud inquiries and fraud reporting. Fraud reporting smart contract 202 may be an executable that writes data to the blockchain, queries the blockchain in a predetermined format, and/or controls the application flow based on predetermined function parameters passed by an API call, or the like. Fraud reporting smart contract 202 may also perform these functions based on the current value of parameters stored in the blockchain and the identity of the caller of fraud reporting smart contract 202 (e.g., transaction account issuer 103, payment service provider 105, payment processing network 107, merchant 109, and/or third party fraud system 111). Fraud reporting smart contract 202 may provide functions for inquiring on potential fraud (e.g., by locating a matching fraud record in the blockchain), reporting fraud, permissioning and/or revoking blockchain addresses belonging to a registered entity, confirming a fraud report, and/or the like. Fraud reporting smart contract 202 may include a program written in a programming language such as, for example, Solidity, or any other suitable programming language. The program may be configured to execute to perform the functions and tasks discussed herein.

The various networks and components in system 200 may be in electronic and/or logical communication using a network. As used herein, the term “network” includes any cloud, cloud computing system or electronic communications system or method that incorporates hardware and/or software components. Communication among the parties may be accomplished through any suitable communication channels, such as, for example, a telephone network, an extranet, an intranet, Internet, point of interaction device (point of sale device, personal digital assistant, cellular phone, kiosk, tablet, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, AppleTalk, IP-6, NetBIOS, OSI, any tunneling protocol (e.g., IPsec, SSH, etc.), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

A network may be unsecure. Thus, communication over the network may utilize data encryption. Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems. Asymmetric encryption in particular may be of use in signing and verifying signatures for blockchain crypto operations.

Fraud inquiry network 210 may be computer based, and may comprise a processor, a tangible non-transitory computer-readable memory, and/or a network interface, along with other suitable system software and hardware components. Instructions stored on the tangible non-transitory memory may allow fraud inquiry network 210 to perform various functions, as described herein. In various embodiments, fraud inquiry network 210 may comprise a user terminal 220, a blockchain wallet 225, a blockchain node 230, a local blockchain database 235, a transaction account processing system 240, and/or a hashing module 245. In various embodiments, user terminal 220 and blockchain wallet 225 may also be separate and/or logically distinct from fraud inquiry network 210 and may be in logical and/or electronic communication with blockchain node 230. The various components in fraud inquiry network 210 may be in direct logical communication with each other via a bus, network, and/or through any other suitable means, or may be individually connected as described further herein.

In various embodiments, user terminal 220 may be configured to allow a user access to system 200, and may enable the user to register with system 200 to enable fraud searching and reporting. For example, a merchant (e.g., merchant 109, with brief reference to FIG. 1) may interact with user terminal 220 to register with participant registration portal 260, as discussed further herein. In that respect, user terminal 220 may be in logical and/or electronic communication with participant registration portal 260, and may be in secure communication using hypertext transport protocol secure (HTTPS) and/or any other suitable secure network protocol. User terminal 220 may comprise any suitable combination of hardware and/or software and may be a computing device such as a server, laptop, notebook, hand held computer, personal digital assistant, cellular phone, smart phone (e.g., iPhone®, BlackBerry®, Android®, etc.), tablet, wearable (e.g., smart watches, smart glasses, smart rings, etc.), Internet of things (IoT) device, smart speaker, or any other similar device. User terminal 220 may comprise software configured to aid user terminal 220 in interacting with components of system 200. For example, user terminal 220 may comprise a blockchain wallet 225.

Blockchain wallet 225 may comprise any suitable distributed-ledger based wallet, such as, for example, Ethereum GETH, Ethereum MetaMask, eth-lightwallet, MyEtherWallet, and/or any other suitable blockchain interface technologies. Blockchain wallet 225 may serve as a blockchain interface accessible by users and applications installed on user terminal 220. For example, blockchain wallet 225 may be configured to register user terminal 220 with the blockchain, request public key (e.g., blockchain address) and private key pairs from blockchain network 101, and/or otherwise access and interact with blockchain account information.

In various embodiments, transaction account processing system 240 may comprise any suitable combination of hardware, software, a mobile application, a web interface, or the like accessible. Transaction account processing system 240 may be configured to receive payment requests. For example, in response to fraud inquiry network 210 being controlled by a merchant, the payment request may be received in response to a consumer initiating a transaction. In that regard, transaction account processing system 240 may comprise an eCommerce website that processes real-time payment requests. Each payment request may comprise any suitable transaction related data, such as, for example, a transaction account number, a transaction instrument number, a transaction instrument expiration date, transaction account billing information (e.g., address, city, state, zip code, etc.), a user email address, an IP address (e.g., from an online purchaser), and/or the like.

Transaction account processing system 240 may be configured to perform an initial fraud assessment on the payment request. Transaction account processing system 240 may perform the initial fraud assessment using any suitable technic or process known in the art. The initial fraud assessment may determine whether (and to what extent) there is a risk of fraud based on the payment request. Transaction account processing system 240 may transmit the payment request to hashing module 245 to inquire whether a payment request is reported or validated as fraudulent and/or to report a proposed fraudulent report.

In various embodiments, hashing module 245 may be in electronic and/or logical communication with transaction account processing system 240, and may be configured to provide cryptographic processes on inputs received from transaction account processing system 240. Hashing module 245 may comprise any suitable combination of hardware and software capable of performing cryptographic operations. Hashing module 245 may be configured to cryptographically process the payment request to generate a payment request hash. Hashing module 245 may generate a hash using all of the data in the payment request, or select data fields from the payment request (e.g., only the transaction instrument number, the transaction instrument expiration date, the billing zip code, the email address, and the IP address). Hashing module 245 may use any suitable hashing algorithm to generate the payment request hash, such as, for example an encryption algorithm from the SHA-2 series of cryptographic methods (e.g., SHA 256), and/or any other encryption technique discussed herein.

Hashing module 245 may transmit the payment request hash to blockchain node 230. Blockchain node 230 may be configured to query local blockchain database 235 to determine whether the payment request hash exists in local blockchain database 235, as discussed further herein. Blockchain node 230 may also be configured to write the payment request hash to blockchain network 101 according to fraud reporting smart contract 202, as discussed further herein.

Fraud reporting network 250 may be computer based, and may comprise a processor, a tangible non-transitory computer-readable memory, and/or a network interface, along with other suitable system software and hardware components. Instructions stored on the tangible non-transitory memory may allow fraud reporting network 250 to perform various functions, as described herein. In various embodiments, fraud reporting network 250 may comprise a participant registration portal 260, a registration repository 265, a fraud reporting system 270, a blockchain interface 275, a blockchain node 280, and a local blockchain database 285. In various embodiments, participant registration portal 260 and registration repository 265 may be separate and/or logically distinct from fraud reporting network 250 and may be in logical and/or electronic communication with blockchain interface 275. In that respect, participant registration portal 260 and registration repository 265 may be part of an issuer system or third party fraud system, for example. The various components in fraud reporting network 250 may be in direct logical communication with each other via a bus, network, and/or through any other suitable means, or may be individually connected as described further herein.

In various embodiments, participant registration portal 260 may be configured to receive registration requests from user terminal 220, validate the registration request, store registration data in registration repository 265, and/or invoke fraud reporting smart contract 202, via blockchain node 280, to store registration data on the blockchain, as discussed further herein. Participant registration portal 260 and/or registration repository 265 may be controlled by an issuer (e.g., transaction account issuer 103), third party fraud system (e.g., third party fraud system 111), and/or any other suitable entity. In various embodiments wherein participant registration portal 260 and/or registration repository 265 is controlled by the transaction account issuer, the registration request may further be validated by comparing the registration request data against stored identifying information (e.g., validating that the provided merchant ID corresponds to a stored merchant ID related to a merchant). Participant registration portal 260 may comprise any suitable combination of hardware, software, and/or database components. The registration request may comprise user identifying information (e.g., a merchant ID, etc.), the public blockchain address, and/or any other desired information. Registration repository 265 may comprise any suitable database, repository, or storage device, and may be configured to store and maintain the registration data using any suitable technique. For example, registration repository 265 may store the registration data grouped by and/or associated by merchant ID, and/or any other suitable identifier.

Fraud reporting system 270 may comprise any suitable combination of software, hardware, database components, and the like, and may be in electronic and/or operative communication with blockchain interface 275. In various embodiments, fraud reporting system 270 may comprise a reporting interface to enable users to transmit proposed fraud reports, validated fraud reports, or the like. Fraud reporting system 270 may receive the fraud reports from any suitable source and/or any user discussed herein. The fraud reports may comprise data similar to the payment request, such as, for example, a transaction account number, a transaction instrument number, a transaction instrument expiration date, transaction account billing information (e.g., address, city, state, zip code, etc.), a user email address, an IP address (e.g., from an online purchaser), and/or the like. Fraud reporting system 270 may be configured to transmit the fraud reports to blockchain interface 275. Blockchain interface 275 may be configured to receive the proposed fraud report and/or validated fraud report from fraud reporting system 270, perform various cryptographic processes on the reports, and/or transmit the hashed reports to blockchain node 280, as discussed further herein. Blockchain interface 275 may comprise any suitable combination of hardware and software capable of interfacing with blockchain node 280 and/or performing cryptographic operations. Blockchain interface 275 may be configured to cryptographically process the fraud report to generate a fraud report hash. Blockchain interface 275 may generate a hash using all of the data in the fraud report, or select data fields from the fraud report (e.g., only the transaction instrument number, the transaction instrument expiration date, the billing zip code, the email address, and the IP address). Blockchain interface 275 may use any suitable hashing algorithm to generate the payment request hash, such as, for example an encryption algorithm from the SHA-2 series of cryptographic methods (e.g., SHA 256), and/or any other encryption technique discussed herein. In various embodiments, blockchain interface 275 may implement the same cryptographic process as hashing module 245 such that the same payment request data would generate the same data hash in both blockchain interface 275 and hashing module 245.

Blockchain interface 275 may transmit the fraud report hash to blockchain node 280. Blockchain node 280 may be configured to query local blockchain database 285 to determine whether the fraud report hash exists in local blockchain database 285, as discussed further herein. Blockchain node 280 may also be configured to write the fraud report hash to blockchain network 101 according to fraud reporting smart contract 202, as discussed further herein.

Referring now to FIGS. 3A-6B, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps depicted in FIGS. 3A-6B, but also to the various system components as described above with reference to FIGS. 1 and 2.

With specific reference to FIGS. 3A and 3B, a process 301 for registration in a fraud management blockchain system is shown according to various embodiments. Various users may interact with user terminal 220 to register with a blockchain wallet and/or register for fraud management via participant registration portal 260. For example, and with brief reference to FIG. 1, transaction account issuer 103, payment service provider 105, payment processing network 107, merchant 109, and/or third party fraud system 111 may register with a blockchain wallet and/or for fraud management via participant registration portal 260, as discussed further herein.

In various embodiments, process 301 may optionally include the user registering with a blockchain wallet prior to registration in the fraud management blockchain system. For example, process 301 may comprise transmitting a blockchain account creation request (step 303). User terminal 220 may access blockchain wallet 225 to request the creation of an asymmetric key pair, including a private key and a public key. Process 301 may comprise generating a private key and public key pair and transmitting the public key to the user (step 305). Blockchain wallet 225 may generate the asymmetric key pair using any suitable technique, such as BIP32, BIP39, BIP44, or the like. The public key may comprise a blockchain address. Blockchain wallet 225 may encrypt and store the private key. Blockchain wallet 225 may transmit the public key to user terminal 220, and user terminal 220 may encrypt and store locally the public key. In various embodiments, blockchain wallet 225 may also encrypt and store locally the public key.

In various embodiments, process 301 may comprise requesting the public blockchain address (step 307). In response to blockchain wallet 225 storing the public blockchain address locally, user terminal 220 may request blockchain wallet 225 to display the public blockchain address. Blockchain wallet 225 may display the public blockchain address via user terminal 220 (step 309). In response to user terminal 220 storing the public blockchain address locally, user terminal 220 may retrieve and display the public blockchain address.

In various embodiments, process 301 may comprise transmitting a registration request (step 311). User terminal 220 may transmit the registration request comprising identifying information (e.g., a merchant ID, existing login credentials, driver's license, etc.) and the public blockchain address to participant registration portal 260. Participant registration portal 260 may parse the registration request to determine the data therein. Participant registration portal 260 may be configured to authenticate the registration request based the identifying information. For example, in response to the identifying information comprising a merchant ID (or similar merchant identifying information), participant registration portal 260 may be configured to compare the merchant ID against stored merchant data to determine whether the merchant has preregistered in the system (e.g., a merchant previously established a relationship with the transaction account issuer). In that respect, in response to the merchant ID matching a stored merchant ID, the registration request may be authenticated.

Process 301 may comprise invoking fraud reporting smart contract 202, via blockchain node 280, in blockchain network 101 to grant fraud management access (step 313). Fraud reporting smart contract 202 may write the registration data to the blockchain. Fraud reporting smart contract 202 may also register the public blockchain address into an internal data storage in fraud reporting smart contract 202 to track and maintain registered public blockchain addresses (e.g., for fraud management access rights). Fraud reporting smart contract 202 returns a fraud management access confirmation to participant registration portal 260 (step 315).

Process 301 may comprise transmitting the registration data to registration repository 265 (step 317). Participant registration portal 260 may transmit the registration data for storage in registration repository 265. Registration repository may store a mapping of the user identifying information and public blockchain address using any suitable technique. Registration repository 265 may confirm a repository update with participant registration portal 260 (step 319). Participant registration portal 260 confirms registration with user terminal 220 (step 321).

With specific reference to FIGS. 4A and 4B, and continued reference to FIG. 1, a process 401 for submitting a fraud inquiry in the fraud management blockchain system is shown according to various embodiments. The fraud inquiry may be transmitted by any suitable user discussed herein (e.g., transaction account issuer 103, payment service provider 105, payment processing network 107, merchant 109, and/or third party fraud system 111) and at any desired point in the transaction process. For example, a merchant, third party fraud system, payment processing network, or the like may transmit a fraud inquiry while processing a payment to ensure that the transaction is not fraudulent.

In various embodiments, process 401 may comprise receiving a payment request (step 403). Transaction account processing system 240 may receive the payment request during a transaction process. The payment request may comprise any suitable transaction related data, such as, for example, a transaction account number, a transaction instrument number, a transaction instrument expiration date, transaction account billing information (e.g., address, city, state, zip code, etc.), a user email address, an IP address (e.g., from an online purchaser), and/or the like.

Process 401 may comprise invoking a fraud inquiry function in hashing module 245 (step 405). For example, transaction account processing system 240 may invoke hashing module 245 in response to determining that the payment request comprises a risk of fraud. Transaction account processing system 240 may invoke the fraud inquiry function in hashing module 245 by passing the payment request. Process 401 may comprise generating a payment request hash (step 407). Hashing module 245 may be configured to cryptographically process the payment request to generate a payment request hash. Hashing module 245 may generate a hash using all of the data in the payment request, or select data fields from the payment request (e.g., only the transaction instrument number, the transaction instrument expiration date, the billing zip code, the email address, and the IP address). Hashing module 245 may use any suitable hashing algorithm to generate the payment request hash, such as, for example an encryption algorithm from the SHA-2 series of cryptographic methods (e.g., SHA 256), and/or any other encryption technique discussed herein. Hashing module 245 may transmit the payment request hash to blockchain node 230 (step 409). For example, hashing module 245 may invoke an inquiry API of blockchain node 230 by passing the payment request hash and/or the public blockchain address.

Process 401 may comprise querying local blockchain database 235 based on the payment request hash (step 411). Blockchain node 230 may query local blockchain database 235 to determine whether the payment request hash matches any stored data (e.g., to determine whether the payment request has been previously reported as suspected and/or validated fraud).

Blockchain node 230 may receive the query results from local blockchain database 235 (step 413). The query results may comprise data indicating whether the query in step 411 returned a match (e.g., “true” if a record existed, “false” if the record did not exist). In various embodiments, the query results may also comprise a fraud confidence level. The fraud confidence level may be based on any suitable factors characterizing the confidence level of a particular fraud record, such as, for example, a fraud record count and a user reputation level of each submitted fraud record. For example, the fraud record count may comprise the total number of times a particular fraud record has been submitted. The higher the count, the higher the confidence level for a particular fraud record. The user reputation level may comprise a score characterizing the reputation of each user that submitted a fraud record. The user reputation level may be based on the accuracy of previous fraud reporting, the count of fraud reports that have been reported and/or validated by others, the volume of unconfirmed fraud reports, and/or the like. In various embodiments wherein the fraud record was reported by a transaction account issuer or similar party, the confidence level may comprise a value indicating a validated fraud record (e.g., 100%, a value of 100 out of a possible 100, etc.).

Blockchain node 230 may transmit the query results to hashing module 245 (step 415). Hashing module 245 may transmit the query results to transaction account processing system 240 (step 417). Process 401 may comprise proceeding with the payment request based on the query results (step 419). For example, transaction account issuer 103 may make a decision on the payment request based on the query result (e.g., “true” or “false”), the fraud record count, and/or the fraud confidence level. As an example, in response to the query result locating a matching fraud record having confidence level of 100%, transaction account processing system 240 may be configured to deny the payment request. In response to the query result locating a matching fraud record having a low fraud record count and a low confidence level (e.g., 10%), transaction account processing system 240 may be configured to proceed with processing the payment request.

With specific reference to FIGS. 5A and 5B, and continued reference to FIG. 1, a process 501 for reporting potential fraud in a fraud management blockchain system is shown according to various embodiments. A proposed fraud report may be transmitted by any suitable user discussed herein (e.g., transaction account issuer 103, payment service provider 105, payment processing network 107, merchant 109, and/or third party fraud system 111) and at any desired point in the transaction process. For example, a merchant, third party fraud system, payment processing network, or the like may transmit a potential fraud report while processing a payment in response to determining locally that the payment request was fraudulently made.

In various embodiments, process 501 may comprise receiving a payment request (step 503). Transaction account processing system 240 may receive the payment request during a transaction process. The payment request may comprise any suitable transaction related data, such as, for example, a transaction account number, a transaction instrument number, a transaction instrument expiration date, transaction account billing information (e.g., address, city, state, zip code, etc.), a user email address, an IP address (e.g., from an online purchaser), and/or the like.

Process 501 may comprise assessing the payment request for fraud (step 505). Transaction account processing system 240 may be configured to assess the payment request for fraud using any suitable technique discussed herein and/or known in the art. In response to determining that the payment request may be fraudulent, transaction account processing system 240 may invoke a fraud update function in hashing module 245 (step 507). Transaction account processing system 240 may invoke the fraud update function by passing the payment request. Hashing module 245 may be configured to cryptographically process the payment request to generate a potential fraud report hash (step 509). Hashing module 245 may generate the hash using all of the data in the payment request, or select data fields from the payment request (e.g., only the transaction instrument number, the transaction instrument expiration date, the billing zip code, the email address, and the IP address). Hashing module 245 may use any suitable hashing algorithm to generate the potential fraud report hash, such as, for example an encryption algorithm from the SHA-2 series of cryptographic methods (e.g., SHA 256), and/or any other encryption technique discussed herein. Process 501 may comprise transmitting the potential fraud report hash to blockchain node 230 (step 511). For example, hashing module 245 may invoke an update API of blockchain node 230 by passing the potential fraud report hash.

In various embodiments, process 501 may comprise invoking fraud reporting smart contract 202 (step 513). Blockchain node 230 may invoke fraud reporting smart contract 202 by passing the potential fraud report hash the public blockchain address. The call to fraud reporting smart contract 202 may be secured using the private key from the user. The public blockchain address included in the call may be digitally signed using a trusted certificate authority (e.g., VeriSign®, DigiCert®, etc.). Process 501 may comprise validating user fraud management authorization (step 515). Fraud reporting smart contract 202 may validate that the public blockchain address associated with the user is authorized to access and/or perform writes to blockchain network 101 (e.g., fraud management access rights) by querying the blockchain to locate registration data (e.g., as added to the blockchain in process 301, with brief reference to FIGS. 3A and 3B).

Process 501 may comprise writing the potential fraud report hash to the blockchain (step 517). In various embodiments, fraud reporting smart contract 202 may query the blockchain to determine whether the potential fraud report hash preexists on the blockchain. In response to locating a match (e.g., the potential fraud was previously reported), fraud reporting smart contract 202 may update the fraud count associated with the fraud report, write data regarding the user, such as, for example, the user's reputation level, and may update the confidence level of the fraud record. In response to determining that the potential fraud was not previously reported, fraud reporting smart contract 202 may create a new record of the potential fraud report including the potential fraud report hash, a confidence level, and/or the like. Fraud reporting smart contract 202 may propagate and/or write the data by writing it to the blockchain or by otherwise transmitting the data to other consensus participants in blockchain network 101. The consensus participants may achieve consensus and add a new ledger for the fraud report to the blockchain. The consensus participants may validate the fraud report, and any other activity on the blockchain, by establishing consensus between the participants based on proof of work, proof of stake, practical byzantine fault tolerance, delegated proof of stake, or other suitable consensus algorithms. The consensus participants may notify blockchain node 230 of a successful write to the blockchain by returning an update confirmation (step 519), or by blockchain node 230 locating the fraud data written on blockchain. Blockchain node 230 may transmit the update confirmation to hashing module 245 (step 521). Hashing module 245 may transmit the update confirmation to transaction account processing system 240 (step 523). Transaction account processing system 240 may decline the payment request as suspected fraud (step 525).

With specific reference to FIGS. 6A and 6B, and continued reference to FIG. 1, a process 601 for reporting validated fraud in a fraud management blockchain system is shown according to various embodiments. A validated fraud report may be transmitted by any suitable user discussed herein (e.g., transaction account issuer 103, payment service provider 105, payment processing network 107, merchant 109, and/or third party fraud system 111) and at any desired point in the transaction process. For example, a transaction account issuer or the like may transmit a validated fraud report while processing and/or settling a payment in response to determining that the payment request was fraudulently made.

In various embodiments, process 601 may comprise calling a confirmation API in blockchain interface 275 to report a positively identified fraudulent payment request (step 603). Fraud reporting system 270 may call the confirmation API by passing the payment request. The payment request may comprise any suitable transaction related data, such as, for example, a transaction account number, a transaction instrument number, a transaction instrument expiration date, transaction account billing information (e.g., address, city, state, zip code, etc.), a user email address, an IP address (e.g., from an online purchaser), and/or the like.

Process 601 may comprise generating a validated fraud report hash (step 605). Blockchain interface 275 may generate the hash using all of the data in the payment request, or select data fields from the payment request (e.g., only the transaction instrument number, the transaction instrument expiration date, the billing zip code, the email address, and the IP address). Blockchain interface 275 may use any suitable hashing algorithm to generate the potential fraud report hash, such as, for example an encryption algorithm from the SHA-2 series of cryptographic methods (e.g., SHA 256), and/or any other encryption technique discussed herein. In various embodiments, blockchain interface 275 may implement the same cryptographic process as hashing module 245 (e.g., as hashed in process 401 and process 501) such that the same payment request data would generate the same data hash in both blockchain interface 275 and hashing module 245. Process 601 may comprise transmitting the validated fraud report hash to blockchain node 280 (step 607). For example, blockchain interface 275 may invoke a validation API of blockchain node 280 by passing the validated fraud report hash.

Process 601 may comprise invoking fraud reporting smart contract 202 (step 609). Blockchain node 280 may invoke fraud reporting smart contract 202 by passing the validated fraud report hash and/or the public blockchain address. The call to fraud reporting smart contract 202 may be secured using the private key from the user. The public blockchain address included in the call may be digitally signed using a trusted certificate authority (e.g., VeriSign®, DigiCert®, etc.). Process 6501 may comprise validating user fraud management authorization (step 611). Fraud reporting smart contract 202 may validate that the public blockchain address associated with the user is authorized to access and/or perform validation writes to blockchain network 101 (e.g., fraud management access rights) by querying the blockchain to locate registration data (e.g., as added to the blockchain in process 301, with brief reference to FIGS. 3A and 3B).

Process 601 may comprise writing the validated fraud report hash to the blockchain (step 613). In various embodiments, fraud reporting smart contract 202 may query the blockchain to determine whether the validated fraud report hash preexists on the blockchain. In response to locating a match (e.g., the validated fraud was previously reported), fraud reporting smart contract 202 may update the fraud count associated with the fraud report, and may update the confidence level of the fraud record to 100%. In response to determining that the validated fraud was not previously reported, fraud reporting smart contract 202 may create a new record of the validated fraud report including the validated fraud report hash, a confidence level of 100%, and/or the like. Fraud reporting smart contract 202 may propagate and/or write the data by writing it to the blockchain or by otherwise transmitting the data to other consensus participants in blockchain network 101. The consensus participants may achieve consensus and add a new ledger for the fraud report to the blockchain. The consensus participants may validate the fraud report, and any other activity on the blockchain, by establishing consensus between the participants based on proof of work, proof of stake, practical byzantine fault tolerance, delegated proof of stake, or other suitable consensus algorithms. The consensus participants may notify blockchain node 280 of a successful write to the blockchain by returning a validation confirmation (step 615), or by blockchain node 280 locating the fraud data written on blockchain. Blockchain node 280 may transmit the validation confirmation to blockchain interface 275 (step 617). Blockchain interface 27 may transmit the validation confirmation to fraud reporting system 270 (step 619).

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “electronic communication” means communication of at least a portion of the electronic signals with physical coupling (e.g., “electrical communication” or “electrically coupled”) and/or without physical coupling and via an electromagnetic field (e.g., “inductive communication” or “inductively coupled” or “inductive coupling”). As used herein, “transmit” may include sending at least a portion of the electronic data from one system component to another (e.g., over a network connection). Additionally, as used herein, “data,” “information,” or the like may include encompassing information such as commands, queries, files, data for storage, and the like in digital or any other form.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a transaction account and (ii) an item (e.g., offer, reward, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

As used herein, big data may refer to partially or fully structured, semi-structured, or unstructured data sets including millions of rows and hundreds of thousands of columns. A big data set may be compiled, for example, from a history of purchase transactions over time, from web registrations, from social media, from records of charge (ROC), from summaries of charges (SOC), from internal data, or from other suitable sources. Big data sets may be compiled without descriptive metadata such as column types, counts, percentiles, or other interpretive-aid data points.

A distributed computing cluster and/or big data management system may be, for example, a Hadoop® cluster configured to process and store big data sets with some of nodes comprising a distributed storage system and some of nodes comprising a distributed processing system. In that regard, distributed computing cluster may be configured to support a Hadoop® distributed file system (HDFS) as specified by the Apache Software Foundation at http://hadoop.apache.org/docs/. For more information on big data management systems, see U.S. Ser. No. 14/944,902 titled INTEGRATED BIG DATA INTERFACE FOR MULTIPLE STORAGE TYPES and filed on Nov. 18, 2015; U.S. Ser. No. 14/944,979 titled SYSTEM AND METHOD FOR READING AND WRITING TO BIG DATA STORAGE FORMATS and filed on Nov. 18, 2015; U.S. Ser. No. 14/945,032 titled SYSTEM AND METHOD FOR CREATING, TRACKING, AND MAINTAINING BIG DATA USE CASES and filed on Nov. 18, 2015; U.S. Ser. No. 14/944,849 titled SYSTEM AND METHOD FOR AUTOMATICALLY CAPTURING AND RECORDING LINEAGE DATA FOR BIG DATA RECORDS and filed on Nov. 18, 2015; U.S. Ser. No. 14/944,898 titled SYSTEMS AND METHODS FOR TRACKING SENSITIVE DATA IN A BIG DATA ENVIRONMENT and filed on Nov. 18, 2015; and U.S. Ser. No. 14/944,961 titled SYSTEM AND METHOD TRANSFORMING SOURCE DATA INTO OUTPUT DATA IN BIG DATA ENVIRONMENTS and filed on Nov. 18, 2015, the contents of each of which are herein incorporated by reference in their entirety.

Any communication, transmission and/or channel discussed herein may include any system or method for delivering content (e.g. data, messages, information, metadata, etc.), and/or the content itself. The content may be presented in any form or medium, and in various embodiments, the content may be delivered electronically and/or capable of being presented electronically. For example, a channel may comprise a website or device (e.g., FACEBOOK®, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE®.pdf document, etc.), an “ebook,” an “emagazine,” an application or microapplication (as described herein), an SMS or other type of text message, an email, FACEBOOK® message, TWITTER® tweet and/or message, MMS, and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a magnetic tape drive, an optical disk drive, etc. The removable storage drive reads from and/or writes to a removable storage unit in a well-known manner. Removable storage unit represents a magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data files transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The computer system or any components may integrate with system integration technology such as, for example, the ALEXA system developed by AMAZON®. ALEXA is a cloud-based voice service that can help you with tasks, entertainment, general information and more. All AMAZON® ALEXA devices, such as the AMAZON ECHO®, AMAZON ECHO DOT®, AMAZON TAP®, and AMAZON FIRE® TV, have access to the ALEXA system. The ALEXA system may receive voice commands via its voice activation technology, and activate other functions, control smart devices and/or gather information. For example, music, emails, texts, calling, questions answered, home improvement information, smart home communication/activation, games, shopping, making to-do lists, setting alarms, streaming podcasts, playing audiobooks, and providing weather, traffic, and other real time information, such as news. The ALEXA system may allow the user to access information about eligible accounts linked to an online account across all ALEXA-enabled devices.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEBSPHERE®, WEBLOGIC®, MOSS®, EDB® Postgres Plus Advanced Server® (PPAS), etc.). In various embodiments, the server may include web servers (e.g. APACHE®, IIS, GWS, SUN JAVA® SYSTEM WEB SERVER, JAVA® Virtual Machine running on LINUX® or WINDOWS®).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

As those skilled in the art will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, OS2, UNIX® OS, LINUX® OS, SOLARIS®, MacOS, and/or the like) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® Operating System, APPLE® MS®, a BLACKBERRY® operating system, and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and communicates a detected input from the hardware to the micro-app.

Any databases discussed herein may include relational, hierarchical, graphical, blockchain, or object-oriented structure and/or any other database configurations. The databases may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Washington), MySQL by MySQL AB (Uppsala, Sweden), MongoDB®, Redis®, Apache Cassandra®, HBase by APACHE®, MapR-DB, or any other suitable database product. Moreover, the databases may be organized in any suitable manner, for example, as data tables or lookup tables. Each record may be a single file, a series of files, a linked series of data fields or any other data structure.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set: e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device, or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, and symmetric and asymmetric cryptosystems. The systems and methods may also incorporate SHA-1 and/or SHA-2 series cryptographic methods as well as ECC (Elliptic Curve Cryptography) and other Quantum Readable Cryptography Algorithms under development.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPE”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® web server software, a MICROSOFT® SQL Server database system, and a MICROSOFT® Commerce Server. Additionally, components such as MICROSOFT® ACCESS® or MICROSOFT® SQL Server, ORACLE®, SYBASE®, INFORMIX® MySQL, INTERBASE®, etc., may be used to provide an Active Data Object (ADO) compliant database management system. In one embodiment, the Apache web server is used in conjunction with a Linux operating system, a MYSQL® database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT®, active server pages (ASP), common gateway interface scripts (CGI), extensible markup language (XML), dynamic HTML, cascading style sheets (CSS), AJAX (Asynchronous JAVASCRIPT® And XML), helper applications, plug-ins, and the like. A server may include a web service that receives a request from a web server, the request including a URL and an IP address (e.g., 10.0.0.2). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE® MQTM (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, APACHE® Hive, JAVA®, JAVASCRIPT®, VBScript, Macromedia Cold Fusion, COBOL, MICROSOFT® Active Server Pages, assembly, PERL, PHP, awk, Python, Visual Basic, SQL Stored Procedures, Spark, Scala, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT®, VBScript or the like. Cryptography and network security methods are well known in the art, and are covered in many standard texts.

In various embodiments, the software elements of the system may also be implemented using Node.js®. Node.js® may implement several modules to handle various core functionalities. For example, a package management module, such as npm®, may be implemented as an open source library to aid in organizing the installation and management of third-party Node.js programs. Node.js may also implement a process manager, such as, for example, Parallel Multithreaded Machine (“PM2”); a resource and performance monitoring tool, such as, for example, Node Application Metrics (“appmetrics”); a library module for building user interfaces, such as for example ReachJS®; and/or any other suitable and/or desired module.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Referring now to FIGS. 3A-6B, the process flows and screenshots depicted are merely embodiments and are not intended to limit the scope of the disclosure. For example, the steps recited in any of the method or process descriptions may be executed in any order and are not limited to the order presented.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

The disclosure and claims do not describe only a particular outcome of fraud management using a distributed database, but the disclosure and claims include specific rules for implementing the outcome of fraud management using a distributed database, and that render information into a specific format that is then used and applied to create the desired results of fraud management using a distributed database, as set forth in McRO, Inc. v. Bandai Namco Games America Inc. (Fed. Cir. case number 15-1080, Sep. 13, 2016). In other words, the outcome of fraud management using a distributed database can be performed by many different types of rules and combinations of rules, and this disclosure includes various embodiments with specific rules. While the absence of complete preemption may not guarantee that a claim is eligible, the disclosure does not sufficiently preempt the field of fraud management using a distributed database at all. The disclosure acts to narrow, confine, and otherwise tie down the disclosure so as not to cover the general abstract idea of just fraud management using a distributed database. Significantly, other systems and methods exist for fraud management, so it would be inappropriate to assert that the claimed invention preempts the field or monopolizes the basic tools of fraud management using a distributed database. In other words, the disclosure will not prevent others from fraud management using a distributed database, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the system and method may include alerting a subscriber when their computer is offline. The system may include generating customized information and alerting a remote subscriber that the information can be accessed from their computer. The alerts are generated by filtering received information, building information alerts and formatting the alerts into data blocks based upon subscriber preference information. The data blocks are transmitted to the subscriber's wireless device which, when connected to the computer, causes the computer to auto-launch an application to display the information alert and provide access to more detailed information about the information alert. More particularly, the method may comprise providing a viewer application to a subscriber for installation on the remote subscriber computer; receiving information at a transmission server sent from a data source over the Internet, the transmission server comprising a microprocessor and a memory that stores the remote subscriber's preferences for information format, destination address, specified information, and transmission schedule, wherein the microprocessor filters the received information by comparing the received information to the specified information; generates an information alert from the filtered information that contains a name, a price and a universal resource locator (URL), which specifies the location of the data source; formats the information alert into data blocks according to said information format; and transmits the formatted information alert over a wireless communication channel to a wireless device associated with a subscriber based upon the destination address and transmission schedule, wherein the alert activates the application to cause the information alert to display on the remote subscriber computer and to enable connection via the URL to the data source over the Internet when the wireless device is locally connected to the remote subscriber computer and the remote subscriber computer comes online.

In various embodiments, the system and method may include a graphical user interface for dynamically relocating/rescaling obscured textual information of an underlying window to become automatically viewable to the user. By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., payment requests, fraud reports, etc.) to prevent a computer from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

In various embodiments, the system may also address the problem of retaining control over customers during affiliate purchase transactions, using a system for co-marketing the “look and feel” of the host web page with the product-related content information of the advertising merchant's web page. The system can be operated by a third-party outsource provider, who acts as a broker between multiple hosts and merchants. Prior to implementation, a host places links to a merchant's webpage on the host's web page. The links are associated with product-related content on the merchant's web page. Additionally, the outsource provider system stores the “look and feel” information from each host's web pages in a computer data store, which is coupled to a computer server. The “look and feel” information includes visually perceptible elements such as logos, colors, page layout, navigation system, frames, mouse-over effects or other elements that are consistent through some or all of each host's respective web pages. A customer who clicks on an advertising link is not transported from the host web page to the merchant's web page, but instead is re-directed to a composite web page that combines product information associated with the selected item and visually perceptible elements of the host web page. The outsource provider's server responds by first identifying the host web page where the link has been selected and retrieving the corresponding stored “look and feel” information. The server constructs a composite web page using the retrieved “look and feel” information of the host web page, with the product-related content embedded within it, so that the composite web page is visually perceived by the customer as associated with the host web page. The server then transmits and presents this composite web page to the customer so that she effectively remains on the host web page to purchase the item without being redirected to the third party merchant affiliate. Because such composite pages are visually perceived by the customer as associated with the host web page, they give the customer the impression that she is viewing pages served by the host. Further, the customer is able to purchase the item without being redirected to the third party merchant affiliate, thus allowing the host to retain control over the customer. This system enables the host to receive the same advertising revenue streams as before but without the loss of visitor traffic and potential customers. More particularly, the system may be useful in an outsource provider serving web pages offering commercial opportunities. The computer store containing data, for each of a plurality of first web pages, defining a plurality of visually perceptible elements, which visually perceptible elements correspond to the plurality of first web pages; wherein each of the first web pages belongs to one of a plurality of web page owners; wherein each of the first web pages displays at least one active link associated with a commerce object associated with a buying opportunity of a selected one of a plurality of merchants; and wherein the selected merchant, the outsource provider, and the owner of the first web page displaying the associated link are each third parties with respect to one other; a computer server at the outsource provider, which computer server is coupled to the computer store and programmed to: receive from the web browser of a computer user a signal indicating activation of one of the links displayed by one of the first web pages; automatically identify as the source page the one of the first web pages on which the link has been activated; in response to identification of the source page, automatically retrieve the stored data corresponding to the source page; and using the data retrieved, automatically generate and transmit to the web browser a second web page that displays: information associated with the commerce object associated with the link that has been activated, and the plurality of visually perceptible elements visually corresponding to the source page.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims.

Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method comprising:
receiving, by a processor, a payment request;
generating, by the processor, a payment request hash by cryptographically processing the payment request using a hashing algorithm;
invoking, by the processor, a fraud reporting smart contract by passing the payment request hash and a public blockchain address to the fraud reporting smart contract; and
querying, by the processor, a local blockchain database to locate a fraud report matching the payment request hash to determine whether the payment request has been previously reported as fraud,
wherein in response to the payment request hash not matching the fraud report, the fraud reporting smart contract is configured to write the payment request hash to the blockchain as a second fraud report.

2. The method of claim 1, wherein the fraud report comprises a confidence level having a fraud report count and a user reputation level.

3. The method of claim 2, wherein in response to the query locating the fraud report matching the payment request hash, the fraud reporting smart contract is configured to increase the fraud report count and the confidence level of the fraud report

4. The method of claim 2, wherein the user reputation level is based on at least one of an accuracy of fraud reporting, a count of fraud reports that have been reported by users, and a volume of unconfirmed fraud reports.

5. The method of claim 2, wherein in response to the fraud report originating from a transaction account issuer, the confidence level comprises a value indicating a validated fraud record.

6. The method of claim 1, wherein the fraud report is cryptographically processed using the hashing algorithm prior to being stored in the blockchain, and wherein the hashing algorithm is a SHA-2 hashing algorithm.

7. The method of claim 1, further comprising:
receiving, by the processor in electronic communication with a participant registration portal, a fraud management registration request comprising the public blockchain address and identifying information;
authenticating, by the processor and via the participant registration portal, the fraud management registration request by comparing the identifying information against stored identity data; and
granting, by the processor and via the participant registration portal, fraud management access rights to the public blockchain address in response to the identifying information matching stored identity data.

8. The method of claim 1, further comprising validating, by the processor, the public blockchain address passed to the fraud reporting smart contract to determine fraud management access rights to the blockchain.

9. The method of claim 1, wherein the payment request comprises at least one of a transaction account number, a transaction instrument number, a transaction instrument expiration date, transaction account billing information, a user email address, and an IP address.

10. A computer-based system for fraud management, comprising:
a processor; and
a tangible, non-transitory memory configured to communicate with the processor, the tangible, non-transitory memory having instructions stored thereon that, in response to execution by the processor, cause the processor to perform operations comprising:
receiving, by a processor, a payment request;
generating, by the processor, a payment request hash by cryptographically processing the payment request using a hashing algorithm;
invoking, by the processor, a fraud reporting smart contract by passing the payment request hash and a public blockchain address to the fraud reporting smart contract; and
querying, by the processor, a local blockchain database to locate a fraud report matching the payment request hash to determine whether the payment request has been previously reported as fraud,
wherein in response to the payment request hash not matching the fraud report, the fraud reporting smart contract is configured to write the payment request hash to the blockchain as a second fraud report.

11. The computer-based system of claim 10, wherein the fraud report comprises a confidence level having a fraud report count and a user reputation level.

12. The computer-based system of claim 11, wherein in response to the query locating the fraud report matching the payment request hash, the fraud reporting smart contract is configured to increase the fraud report count and the confidence level of the fraud report.

13. The computer-based system of claim 11, wherein the user reputation level is based on at least one of an accuracy of fraud reporting, a count of fraud reports that have been reported by users, and a volume of unconfirmed fraud reports.

14. The computer-based system of claim 10, wherein the fraud report is cryptographically processed using the hashing algorithm prior to being stored in the blockchain, and wherein the hashing algorithm is a SHA-2 hashing algorithm.

15. The computer-based system of claim 10, further comprising validating, by the processor, the public blockchain address passed to the fraud reporting smart contract to determine fraud management access rights to the blockchain.

16. An article of manufacture including a non-transitory, tangible computer readable storage medium having instructions stored thereon that, in response to execution by a computer based system, cause the computer based system to perform operations comprising:
receiving, by a processor, a payment request;
generating, by the computer based system, a payment request hash by cryptographically processing the payment request using a hashing algorithm;
invoking, by the computer based system, a fraud reporting smart contract by passing the payment request hash and a public blockchain address to the fraud reporting smart contract; and
querying, by the computer based system, a local blockchain database to locate a fraud report matching the payment request hash to determine whether the payment request has been previously reported as fraud,
wherein in response to the payment request hash not matching the fraud report, the fraud reporting smart contract is configured to write the payment request hash to the blockchain as a second fraud report.

17. The article of manufacture of claim 16, wherein the fraud report comprises a confidence level having a fraud report count and a user reputation level, and wherein the user reputation level is based on at least one of an accuracy of fraud reporting, a count of fraud reports that have been reported by users, and a volume of unconfirmed fraud reports.

18. The article of manufacture of claim 17, wherein in response to the query locating the fraud report matching the payment request hash, the fraud reporting smart contract is configured to increase the fraud report count and the confidence level of the fraud report.

19. The article of manufacture of claim 16, wherein the fraud report is cryptographically processed using the hashing algorithm prior to being stored in the blockchain, and wherein the hashing algorithm is a SHA-2 hashing algorithm.

20. The article of manufacture of claim 16, further comprising validating, by the processor, the public blockchain address passed to the fraud reporting smart contract to determine fraud management access rights to the blockchain.
